(19) United States
(12) Patent Application Publication
(10) Pub. No.: US 2004/0258026 A1
(43) Pub. Date: Dec. 23, 2004

(54) Method of uplink scheduling for multiple antenna systems

(76) Inventor: Kin Nang Lau, Parsippany, NJ (US)

Correspondence Address: Lucent Technologies Inc., Docket Administrator (Room 3J-219), 101 Crawfords Corner Road, Holmdel, NJ, 07733-3030, US

(21) Appl. No.: 10/465,468

(22) Filed: Jun. 19, 2003

(51) Int. Cl. H04B 7/216

(52) U.S. Cl. 370/335; 370/252

(57) ABSTRACT

A method of scheduling data transmission and reception over an uplink for a wireless communication system employing a multiple antenna scheme. The method enables the uplink transmission of data using one or more transmission paths for each user. The method of scheduling of the users may consider various factors, including the air interface characteristics, deadlines, uplink data transfer sizes and/or uplink data rates of each user. These factors for each user may be transmitted to the scheduler residing in a base station, for example, through an initiation signal, such as an uplink service request. The scheduler may use a maximum fairness scheme, a maximum throughput scheme, a maximum relative throughput scheme or a proportional fairness scheme for sharing resources amongst the users.

### FIELD OF THE INVENTION

The present invention relates to wireless communications, and more particularly, to a method of uplink scheduling for data communication.

### BACKGROUND OF THE INVENTION

Wireless communications systems employ a number of geographically distributed, cellular communication sites or base stations. Each base station supports the transmission and reception of communication signals to and from stationary or fixed, wireless communication devices or units. Each base station handles communications over a particular region commonly referred to as a cell/sector. The overall coverage area for a wireless communications system is defined by the union of cells for the deployed base stations. Here, the coverage areas for adjacent or nearby cell sites may overlap one another to ensure, where possible, contiguous communications coverage within the outer boundaries of the system.

When active, a wireless unit receives signals from at least one base station over a forward link or downlink and transmits signals to at least one base station over a reverse link or uplink. There are many different schemes for defining links or channels for a cellular communication system, including, for example, TDMA (time-division multiple access), FDMA (frequency-division multiple access), and CDMA (code-division multiple access) schemes. In CDMA communications, different wireless channels are distinguished by different channelization codes or sequences that are used to encode different information streams, which may then be modulated at one or more different carrier frequencies for simultaneous transmission. A receiver may recover a particular stream from a received signal using the appropriate code or sequence to decode the received signal.

For voice applications, conventional cellular communication systems employ dedicated links between a wireless unit and a base station. Voice communications are delay-intolerant by nature. Consequently, wireless units in wireless cellular communication systems transmit and receive signals over one or more dedicated links. Here, each active wireless unit generally requires the assignment of a dedicated link on the downlink, as well as a dedicated link on the uplink.

Service providers continue to pursue methods for increasing the capacity. One area gaining increasing attention involves the use of multiple antenna systems, such as single input multiple output (“SIMO”), multiple input single output (“MISO”) and multiple output (“MIMO”) schemes, including Bell Labs Layered Space-Time (“BLAST”), for example. These multiple antenna systems create a multitude of possible paths for the transmission of information from one or more transmit antennas of one multiple antenna system to one or more receive antennas of another multiple antenna system.

With the explosion of the Internet and the increasing demand for data, resource management has become a growing issue in cellular communication systems generally, and those supporting multiple antenna schemes particularly. Next generation wireless communication systems are expected to provide high rate packet data services in support of Internet access and multimedia communication. Unlike voice, however, data communications are relatively delay tolerant and typically bursty. Data communications, as such, do not require dedicated links on the downlink or the uplink, but rather enable one or more channels to be shared by a number of wireless units. By this arrangement, each of the wireless units on the uplink competes for available resources. Resources to be managed in the uplink in a multiple antenna system, for example, include the received power at the base station, and the interference created by each user to other users in the same sector or cell, as well as in other sectors or cells, for example. This is in contrast to the resources to be managed on the downlink, including fixed transmit power budgets.

In view of the need for resource management in data communication, it should be noted that the ultimate bit rate in which a communication system operates might be derived using Shannon's limit to information theory. Shannon's limit is based on a number of different parameters. These Shannon's limit parameters include, for example, the total power radiated at the transmitter, the number of antennas at the transmitter and receiver, available bandwidth, noise power at the receiver, and the characteristics of the propagation environment.

The transmission rate of data in a wireless communication system using a multiple antenna scheme, for example, may depend on the total power available at the particular wireless unit, the quality of the radio link, and the received power and interference levels that may be tolerated by all the base stations receiving the signal from the wireless unit. Quality of service provisioning will attempt to guarantee a desired throughput or delay for a specific application for each wireless unit. On the other hand, effective resource management enhances the efficiency of the wireless communications system, thereby improving the overall system throughput. Additionally, there may be other tangible benefits to “smart” or “intelligent” channel utilization methods, such as hybrid ARQ and/or incremental redundancy, for example.

Presently, resource management schemes for data applications have concentrated on single antenna communications systems, as opposed to with multiple antenna systems, as well as on the downlink. These known solutions have proposed centralizing the operations at the base station or equivalent (e.g., inter-working function). The base station provides a route for all requests from wireless units on the uplink, as well as all responses to the wireless unit on the downlink. Consequently, the base station serves as a focal point for all requests even if the data has to be fetched from another source location. The base station, therefore, may be used as a server for performing a centralized scheduling operation in determining which wireless units receive data, when they may receive the data, for how long they may receive the data, and at what rate they may receive data.

Resource management and channel allocation on the uplink, to date, has been primarily treated as a “distributed control” concern. Here, the base station does not control the operations by assigning service order priorities. The base station, however, may supervise access to the uplink and monitor operations via slow or fast power control. For example, in CDMA2000 1x systems, each wireless unit makes a request for an uplink channel at a specific rate. The base station monitors the interference patterns and determines whether to allow the wireless unit making the request access to an uplink channel. If the wireless unit is granted access, subsequent transmissions may be power controlled. In 1xEV-DO systems, uplink access may be controlled by allowing each wireless unit to transmit autonomously, initially at the lowest rate in the rate set. At every subsequent transmission, each wireless unit autonomously doubles its data rate, while the base station continuously manages the channel via power control. If the aggregate received power at the base station or the interference to each wireless unit exceeds a predefined threshold, the base station orders all wireless units to reduce their data rates.

These known schemes for managing resources and channel allocation in data applications on the uplink have a number of shortcomings. Firstly, these schemes do not contemplate a wireless communication system employing a multiple antenna configuration. Furthermore, wireless units on the uplink are not scheduled for gaining access to the base station's resources. The wireless communication system's operation, consequently, is neither efficient nor is its throughput optimized. Moreover, quality of service requirements is considerably more difficult to realize without a scheduling system.

Therefore, a need exists for a scheduling system to manage a base station's resources and channel allocation in data applications with respect to wireless units on the uplink for a wireless communication system employing a multiple antenna scheme.

### SUMMARY OF THE INVENTION

The present invention provides a method of scheduling data transmission and reception over an uplink for a wireless communication system employing a multiple antenna scheme. More particularly, the present invention offers a method of scheduling wireless units or users for transmitting data over the uplink using one or more transmission paths for each user. For the purposes of the present invention, these one or more transmission paths may be enabled by the multiple antenna scheme of the wireless communication system. The scheduling of users may consider various factors, including air interface characteristics, deadlines, uplink data transfer sizes and/or uplink data rates of each user. These factors for each user may be transmitted to the scheduler residing in a base station, for example, through an initiation signal, such as an uplink service request. Thereafter, the scheduler may use a maximum fairness scheme, a maximum throughput scheme, a maximum relative throughput scheme or a proportional fairness scheme for sharing resources amongst the users.

In one embodiment, the present invention provides for a method of scheduling a plurality of users in a multiple antenna wireless communication system. The method includes transmitting an uplink service request from a first user of the plurality to request a schedule for transmitting data on an uplink. The uplink service request may include the air interface characteristics, the deadline, the uplink data transfer size and/or the uplink data rate of the first user. Thereafter, the data from the first user may be transmitted on the uplink using at least one of a plurality of transmission paths in response to the schedule determined. This schedule may be determined in response to the air interface characteristics, the deadline, the uplink data transfer size and the uplink data rate of the first user in comparison with other users.

In another embodiment, the present invention provides for a method of scheduling a plurality of users in a multiple antenna wireless communication system. The method includes receiving an uplink service request from at least two users of the plurality. Each user's uplink service request includes air interface characteristics, deadline, and/or uplink data transfer size. Each of the at least two users may then be scheduled for transmitting data on an uplink using at least one of a plurality of transmission paths. The schedule may be determined be in response to the air interface characteristics, the deadline, the uplink data transfer size and/or the uplink data rate of the at least two users.

### BRIEF DESCRIPTION OF THE DRAWINGS

The present invention will be better understood from reading the following description of non-limiting embodiments, with reference to the attached drawings, wherein below:

FIG. 1 depicts a flow chart of an embodiment of the present invention;

FIG. 2 depicts an aspect of the present invention;

FIG. 3 depicts another aspect of the present invention;

FIG. 4 depicts yet another aspect of the present invention;

FIG. 5 depicts still another aspect of the present invention;

FIG. 6 depicts a table illustrating an aspect of the present invention; and

FIG. 7 depicts a flow chart of another embodiment of the present invention.

It should be emphasized that the drawings of the instant application are not to scale but are merely schematic representations, and thus are not intended to portray the specific dimensions of the invention, which may be determined by skilled artisans through examination of the disclosure herein.

### DETAILED DESCRIPTION

Considerable research efforts have been devoted to enhancing the link level throughput using multiple-antenna technologies. To effectively exploit the performance potential of multiple-antenna technologies, resource management of the system may be beneficial. Consequently, a need exists for a scheduling system to manage a base station's resources and channel allocation in data applications with respect to wireless units on the uplink for a wireless communication system employing a multiple antenna scheme.

The present invention provides a method of scheduling data transmission and reception over an uplink for a wireless communication system employing a multiple antenna scheme. More particularly, the present invention offers a method of scheduling wireless units or users for transmitting data over the uplink using one or more transmission paths for each user. For the purposes of the present invention, these one or more transmission paths may be made available by the multiple antenna scheme of the wireless communication system. The scheduling of the users may consider various factors, including the air interface characteristics, deadlines, uplink data transfer sizes and/or uplink data rates of each user. These factors may be transmitted for each user to the scheduler residing in a base station, for example, through an initiation signal, such as an uplink service request. Thereafter, the scheduler may use a maximum fairness scheme, a maximum throughput scheme, a maximum relative throughput scheme or a proportional fairness scheme for sharing resources amongst the users.

Referring to FIG. 1, a flow chart 10 of an embodiment of the present invention is illustrated. Flow chart 10 depicts a method of uplink scheduling a plurality of wireless units or users. The method reflected in flow chart 10 addresses users seeking to transmit data over the uplink through one or more transmission paths for each user.

Initially, each user seeking to transmit data over the uplink transmits an initiation signal to a base station within the cell/sector. This initiation signal may be realized by an uplink service request, for example. Thereafter, the base station within the cell/sector receives each uplink service request from a plurality of users seeking uplink transmission service (step 20).

Upon receiving each of these requests within a defined time period, the base station collects information regarding each wireless user (step 30). The base station may collect, compile, accumulate, and/or sort this information, which includes the air interface characteristics, deadlines, uplink data transfer and/or uplink data rates for each wireless user seeking uplink transmission service. This information may be received by the base station through a number of different methods. For example, the user information may be transmitted as part of the uplink service request, enabling the base station to collect this information upon receipt of the signal.

Subsequently, the base station determines the schedule for wireless users seeking uplink transmission service (step 40). This determination may be based on information collected, compiled, accumulated and sorted from each user. More particularly, the base station may initially examine the air interface characteristics of each user to determine which of the plurality of users may be scheduled. If any user(s) is deemed not worthy of scheduling because of some property, such as relatively poor air interface characteristics, for example, the method may schedule the remaining users. For the purposes of the present disclosure, these remaining users may be termed qualified users.

Once the qualified users have been identified, any one of a number of methods for scheduling may be employed thereafter to enable each qualified user to transmit their associated data over the uplink. These scheduling techniques may include, for example, a maximum throughput scheme or a maximum fairness scheme for sharing the resources of the base station amongst the users to be scheduled. Alternatively, hybrid schemes using maximum throughput and maximum fairness, such as a maximum relative throughput scheme or a proportional fairness scheme may also be employed.

In accordance with a maximum throughput scheme, the method may schedule qualified users for uplink transmission by any one of the properties made available from the information by collected regarding each wireless user. Thusly, the method may select the user or users with the most desirable air interface characteristics, deadlines, uplink data transfer size, and/or uplink data rate. For example, a qualified user with the most desirable air interface characteristics may be scheduled for data transmission over the uplink first using one or more transmission paths made available by the multiple antenna system. The method may schedule the next most desirable air interface characteristics for transmission over the uplink using one or more additional transmission paths, other than those paths already associated with the first user. This next user may be scheduled concurrent with and/or subsequent to the first user.

In accordance with a maximum fairness scheme, the method may schedule qualified users for uplink transmission by sharing the available resources. Here, the available resources may be divided amongst the qualified users equally. Sharing the resources in this manner may also be known as a round-robin method. In the alternative, the available resources divided amongst users using a weighted system based on the collected information from each qualified user. This later approach may also be known as a proportional fairness scheme and/or a maximum relative throughput scheme.

As noted hereinabove, multiple antennas systems create at one transmission path between each qualified user and its corresponding base station. Consequently, the method also includes the step of determining one or more transmission paths to be employed by each qualified user in one embodiment of the present invention. This determining step may be performed by the scheduler concurrent with scheduling each qualified user (step 40). The scheduler, having the air interface characteristics, deadlines, uplink data transfer size, and/or uplink data rate of each qualified wireless user at its disposal, may determine the optimum transmission path or paths. In one example, the matrix coefficients of the air interface characteristics of each qualified user are employed in the step of determining the optimal transmission path. To maximize system performance of a wireless communication employing a multiple antenna scheme, each qualified user to be scheduled should have at least one distinct transmission path assigned thereto. Thusly, a first qualified user scheduled for uplink transmission should use one or more transmission paths, while a second qualified user scheduled for uplink transmission should use at least another of the transmission paths during or after the first user is scheduled.

It should be noted that in multi-user configurations with bursty data sources, a number of issues might be contemplated regarding system level performance. Specifically, in a system having K users, performance may be expressed as U(R₁, . . . ,R_{K}), where U is a utility function, Rₖ denotes the average throughput of user k. In addition to the physical or link layer, a method for uplink scheduling in the medium access control (“MAC”) layer may play a role in determining the multi-user system performance. For example, to maximize the system capacity, the utility function may be given by the following mathematical expression:

$${U}_{max thp} ( {R}_{1} , … , {R}_{K} ) = {\sum }_{k = 1}^{K} {R}_{k}$$

where Uₘₐₓₜₕₚ refers to the utility function in a system employing a maximum throughput scheme, and R₁, . . . ,R_{K} refers to average throughput for users 1 through K.

Schedulers designed to optimize the above utility function may result in maximum system capacity. However, users with a relatively poor channel condition may be discriminated against, and thusly, suffer from starvation. To strike a balance between system capacity and fairness among users, a proportional fairness may be employed in the alternative. A scheduler may be termed proportionally fair if it optimizes the utility function defined by the following formula:

$${U}_{PF} ( {R}_{1} , … , {R}_{K} ) = {\sum }_{k = 1}^{K} log ( {R}_{k} )$$

where U_{PF} refers to the utility function in a system employing a proportional fairness scheme, and R₁, . . . ,R_{K} refers to average throughput for users 1 through K.

For a maximal throughput scheduler, the user with the most desirable signal to interference ratio (“SIR”) or most desirable channel condition may be selected. This approach may exemplify the principle that this user can utilize the limited bandwidth more effectively (e.g., higher throughput). For a scheduler employing proportional fairness, however, a single user with the largest

$$\frac{{r}_{k}}{{R}_{k}}$$

may be selected, where

$${R}_{k} ( t + 1 ) = \frac{1}{{t}_{c}} {r}_{k} ( t ) + ( 1 - \frac{1}{{t}_{c}} ) {R}_{k} ( t )$$

is the long term average data rate of user k and t_{c} is the averaging constant.

While these maximum-based or greedy algorithms may be optimal for single antenna systems, these maximum-based and/or greedy schemes may, in some circumstances, be sub-optimal multiple antenna systems. It has been estimated that the performance gaps may reach up to 5-6 dB when compared with the optimal algorithms. Yet, the computational complexity of the optimal scheduler may also be relatively large. Consequently, the need exists for an heuristic scheduler over the uplink (e.g., reverse link) of a multiple antenna wireless system consisting of K mobiles and one base station.

To realize the method of scheduling of the present invention, the system utility functions may be modeled using the following mathematical expression:

U(R₁, . . . ,R_{K})=E[G(r₁, . . . ,r_{K})]

where E[] denotes an expectation with respect to the channel matrices, r_{K} denotes instantaneous user data rates, and G() is a convex utility function. In this example, each mobile may have a single transmit antenna, while the base station may have n_{R} receive antennas.

### Channel Encoding And Decoding

Channel encoding and decoding frames may be in bursts shorter than the coherence time of the fading channel. This burst model may be realistic for wireless systems offering services such as high speed data packet access (“HSDPA”) and high data rate (“HDR”), for example, and having relatively slow mobility. Here, the typical burst duration may last for 2 ms—e.g., shorter than the coherence time of fading channels with pedestrian mobility.

### Minimum Mean-Squared Error (“MMSE”) Processing Constraint

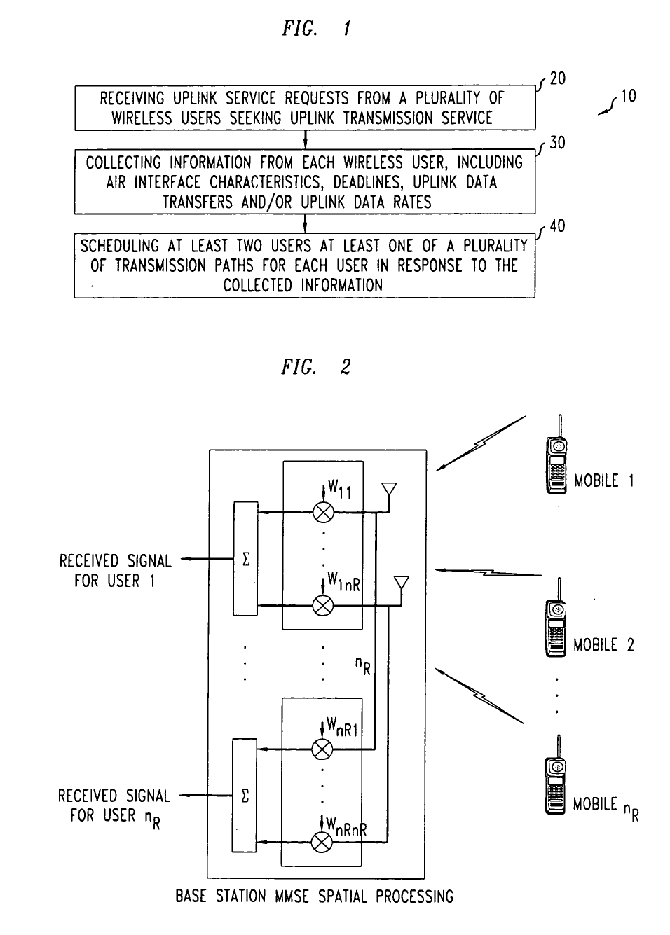

Base stations may generally have multi-user detection capability, allowing for simultaneous transmissions of multiple users. The implementation complexity of the optimal multi-user detector may be shown to be exponential. Consequently, a linear processing constraint, such as MMSE processing, on the link layer of the base-station may be employed. At any fading block, only n_{R} users may be selected to transmit at the same time. Signals from these n_{R} simultaneous transmissions may be separated by MMSE spatial processing. This is illustrated in FIG. 2, which depicts a block diagram of the MMSE multiuser detector at the base station.

Given the channel matrices of all users, {h₁, . . . , hₖ}, where hₖ is the n_{R}×1 channel matrix of user k, the received signal at the base station is given by the following formula:

$$y = {\sum }_{k = 1}^{K} {h}_{k} {x}_{k} + {z}_{k}$$

where y is the signal received at the base station, xₖ is the transmitted signal from user k, zₖ is the n_{R}×1 channel noise. To obtain the information for user k, a linear weight vector wₖ may be applied to the receive vector. This weight vector may be chosen to minimize the mean square error using the following mathematical expression:

$${w}_{k} = \underbrace{arg min}_{w} \{ {\vert {w}^{*} y - {x}_{k} \vert}^{2} \}$$

where arg min is a mathematical function performed, in part, on the squared difference between the signal received at the base station and the transmitted signal from user k.

### Mobile Power Constraint

As bursts may be relatively short in duration, power adaptation within a coding frame may be unnecessary. This may be attributable to the relatively high correlation of channel fading within the entire coding frame. The transmitted power of the kth wireless unit may be termed to be pₖ≦Pₖ, where pk is the power allocation for the kth wireless unit and Pk is the transmit power for the kth mobile terminal.

### The Optimization Problem

A binary indication variable, aₖ∈{0,1}, may first be introduced for a user k. Note that aₖ=1 for user k may be selected, while aₖ=0 for user k may not be selected. The scheduling problem with MMSE processing constraint could be transformed into the following optimization problem. Given the realization of channel matrices for all mobile terminals, {h₁, . . . ,h_{K}}, the optimal resource allocation vector (a₁, . . . ,a_{K}) may be determined along with the corresponding power allocation vector (p_{1, . . . ,p}_{K}) so that the system utility function, G(r₁, . . . ,r_{K}), may be maximized and

$${\sum }_{k = 1}^{K} {α}_{k} \leq {n}_{R} .$$

The present invention may provide an heuristic uplink scheduling method for multiple antenna systems based on the genetic algorithm framework. A genetic algorithm is a method of heuristic optimization based on the concept of evolution and genes. It is provides a family of computational models for optimizing functions with local maxima. Unlike other deterministic optimization algorithms, genetic algorithms may be viewed as stochastic. Through the process of evolution and mutation, the solution(s) from a genetic algorithm may not be limited at the local maxima, and, therefore, may have a higher probability of finding the global maxima.

Genetic algorithms may well be suited for scheduling methods associated with the space-time issues arising, for example, from multiple antenna schemes. This is attributable to the fact that the optimizing variable (a₁, . . . ,a_{K}) may be a binary string represented naturally by a chromosome of the genetic algorithm without requiring extra encoding. For the purposes of the present disclosure, a chromosome is a testing string of an optimizing variable. For example, if we want to optimize a function—e.g., f(x₁, . . . ,x_{N})—a chromosome may be a testing point (x₁, . . . , x_{N}) in the N-dimensional optimization space. Genetic algorithms may be generally employed in conjunction with methods, where the original problem may be modeled as a mathematical optimization problem with respect to a certain function, such as a general utility function, for example.

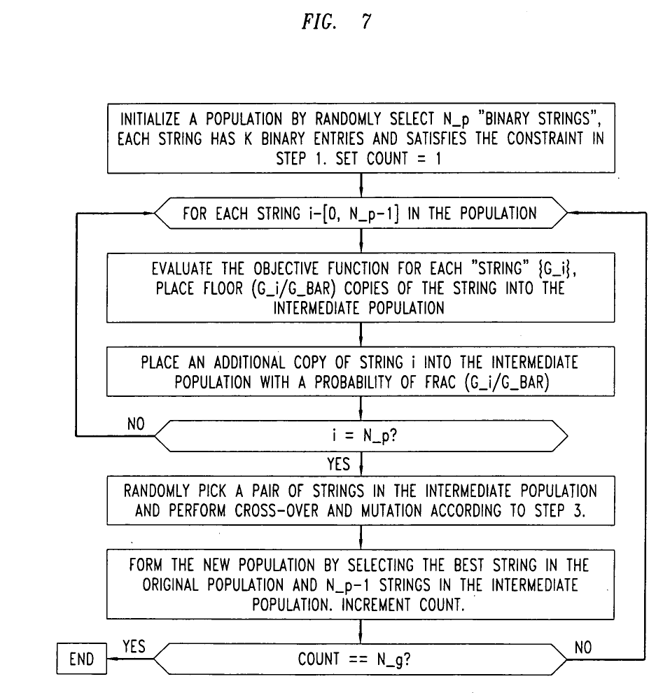

The application of an adaptive mutation rate to a traditional genetic algorithm may provide a unique method for scheduling uplink transmissions through multiple paths based on the diversity of the population. An exemplary flow chart for a method employing a genetic algorithm for scheduling uplink transmissions through multiple paths based on the diversity of the population is shown in FIG. 7. For the purposes of the present invention, the mutation rate controls the “stickiness” of the optimization algorithm to the local maxima. A high mutation rate in an optimization algorithm may be aggressive in exploring new points in the space. In contrast, a low mutation rate in an optimization algorithm may be conservative in trying out new points in the optimization space. Naturally, if the spread of the population is large initially, the mutation rate may be desirable small for better stability. On the other hand, if the spread of the population is small (e.g., stuck at local maxima), an increase in the mutation rate may be desirable so as to introduce randomness and support the exploration of new space beyond the local maxima. For the purposes of the present invention, diversity refers to the spread of the population.

As described hereinabove, a genetic algorithm may be initiated with a random set of points in the initial population. These points may converge to some optimal point(s) as quickly as possible. However, there may be some chance that the converged point is actually a local maxima rather than global maxima. Consequently, randomness may be introduced again through mutation into the population. In so doing, new points may also be explored.

In an exemplary method of an adaptive mutation rate applied to a genetic algorithm for scheduling uplink transmissions through multiple paths, a population with Nₚ chromosomes is first initialized. For the purposes of the present disclosure, a population refers to a set of Nₚ testing points in the optimization space. Here, a chromosome may be mathematically represented by a sample of the optimizing variable (a₁, . . . ,a_{K}), where aₖ∈{0,1}. The starting population—e.g., the initial set of Nₚ points (or chromosomes)—may be initialized with Nₚ randomly picked chromosomes that may satisfy the following mathematical constraint:

$${\sum }_{k = 1}^{K} {α}_{k} \leq {n}_{R} .$$

Thereafter, the fitness of each randomly selected chromosome in the current population, A(i)=(a₁(i), . . . ,a_{K}(i)), may be evaluated. For the purposes of the present disclosure, fitness refers to the value of the utility function. A point or chromosome having a large utility function value may be deemed fitter than a point or chromosome with a relatively lower utility value. It should be noted that as genetic algorithms are iterative, during any iteration, a population of testing points or chromosomes might exist. This set of points may be referred to as the current population, where the term current refers to the present iteration.

This fitness evaluation step may be based on the utility function Gᵢ=G(r₁, . . . ,r_{K}). Here, Gᵢ stands for the utility function value for the i-th testing point or the i-th chromosome, while G_bar may refer to the average utility function value for all the members in the population. If

$$\overline{G} = \frac{1}{{N}_{p}} {\sum }_{i}^{} {G}_{i}$$

deemed an average fitness within the current population, the integer portion of Gᵢ/\overline{G} may indicate how many copies of that chromosome i may be directly placed in the intermediate population. In the current population, there may be Nₚ points or chromosomes such that each of these points (e.g., for I=1:Nₚ), their fitness may be examined based on Gi/G_bar (Gᵢ/\overline{G}). From the original population, an intermediate population may be formed in such a way that the fitter points (e.g., chromosomes) may have a higher chance of survival—or in other words, have a higher chance of existence in the intermediate population. On the other hand, a degree of randomness through mutation may be introduced into the members of the intermediate population as well.

An additional copy of that chromosome may be placed in the intermediate population with a probability equal to the fractional part of Gᵢ/\overline{G}. In this manner, fitter chromosomes may be allowed a greater likelihood to propagate into the next population. Next population here refers to the new population set after the selection, mutation and cross-over operations. The next population may be used as the “original population” in the next iteration of the algorithm. Hence, as the iterative steps proceed, the population gradually evolves.

For example, if Nₚ=3, the original population may have 3 points (e.g., chromosomes) with G_I={2.5, 3, 1} and the G_bar=1+2.5+3/3=2.16. For chromosome 1, if G_{—}1/G_bar=1.16, there may be one copy of chromosome 1 placed in the intermediate population and a 0.16 chance of placing an additional copy of chromosome 1 into the intermediate population. For chromosome 2, if G_{—}2/G_bar=1.38 such that there may be one copy of chromosome 2 placed in the intermediate population and a 0.38 chance of placing an additional copy of chromosome 2 into the intermediate population. For chromosome 3, if G_{—}3/G_bar=0.46, there may be one copy of chromosome 3 placed in the intermediate population. Thereafter, three (3) points may be randomly selected out of the intermediate population, wherein the fitter chromosomes in the original population may have a higher chance of surviving the selection process.

Subsequently, the method randomly selects a pair of chromosomes in the intermediate population and recombines the two (2) parents into two (2) offspring according to cross-over and mutation rules. Cross-over and mutation rules may be used to introduce randomness into the population so that the chromosomes or testing points may not be stuck at a local maxima.

The cross-over operation may be characterized using a crossover probability P_{c}. For every selected pair of parents, there may be a probability, P_{c}, of performing a crossover operation. By a crossover operation, a randomly selected crossover point (e.g., between 1 and K) may be selected for the pair of chromosomes. The two parents may be split respectively in the cross over point selected and the two offspring obtained by crossing the fragments of the two (2) parents, as depicted in FIG. 3. FIG. 3 illustrates a crossover and mutation operation. For every bit in the chromosomes of the offspring, there is a mutation rate, pₘ, of toggling the bit (e.g., if the original bit is 0, then the toggle bit is 1, and vice versa), which may otherwise be referred to as mutation operation. The mutation rate may be adaptive to the fitness statistics of the current generation and may be expressed by the following mathematical expression:

$${p}_{m} = \frac{1}{{β}_{1} + {β}_{2} {σ}_{G} / \overline{G}}$$

where Pₘ is the mutation rate, and σ_{G} is the standard derivation of the fitness of the current population (before selection), and β₁, β₂ are each parameters of the genetic algorithm used to control the degree of adaptation on the mutation rate. For example, if β₁, β₂ are equal, the mutation rate may no longer be adaptive

The method may then replace the original population with the new population. Thereafter, the method repeats the step of evaluating the fitness of each randomly selected chromosome in the current population—such that fitter chromosomes may be allowed a greater likelihood to propagate into the next population—and the step of randomly selecting a pair of chromosomes and recombining the two (2) parents into two (2) offspring. These steps are repeated until the number of iterations reaches N_{g}.

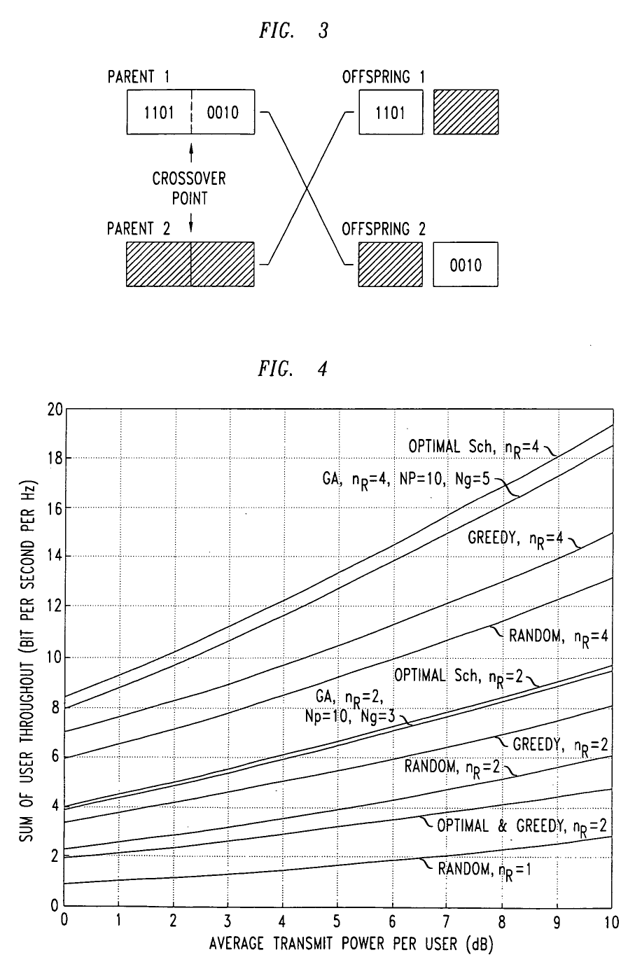

Referring to FIG. 4, the performance of the scheduling method employing a maximal throughput scheme with respect to n_{R} and signal to interference (“SIR”) ratio is illustrated. As shown, wireless users may be homogeneous in terms of path loss and transmit power constraint. It may be observed that a significant gain in capacity is achieved by increasing the number of receive antenna n_{R}. This may be attributed to an n_{R}×n_{R} distributed configuration, where one n_{R} refers to transmit antennas and the other one n_{R} refers to receive antennas.

In one example, there may be a 2 times and a 4 times total system capacity gain when comparing with n_{R}=1 at SNR=10 dB for n_{R}=2,4 respectively. On the other hand, the performance of traditional greedy algorithms may coincide with the optimal scheduler if n_{R}=1. However, there may be a SIR penalty of 2.5 and 4.5 dB between the greedy and the optimal performance at n_{R}=2,4 respectively (at SIR=5 dB). It may also be observed that the genetic algorithm has negligible performance loss compared with the optimal scheduler.

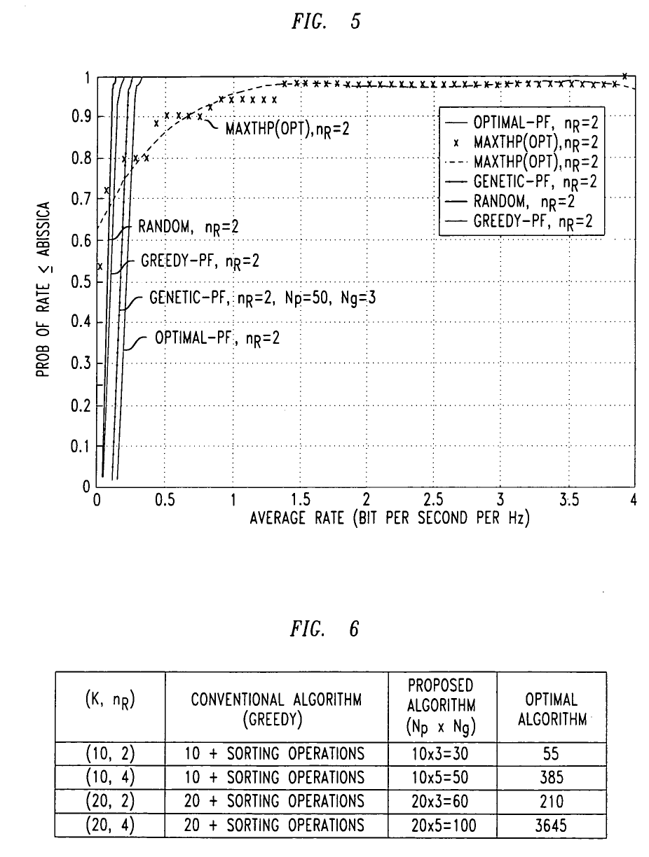

Referring to FIG. 5, the performance of the scheduling method employing a proportional fairness scheme is illustrated. More particularly, a culmulative distribution function (“CDF”) of mobile terminal's throughput is plotted for n_{R}=2 and an SIR=10 dB. The y-axis illustrates the probability of mobile terminals acquiring a throughput less than or equal to the value in x-axis. While maximal throughput scheduler may achieve the highest total system capacity, the chance of mobile terminals achieving such a resultant throughput appears low. On the other hand, for a method of scheduling employing a proportional fairness scheme, the wireless users may have a higher chance of achieving a reasonable throughput, even if the absolute maximum throughput achieved by any mobile terminal may be smaller than the maximal throughput scheduler. For example, at 90% service guarantee level (e.g., 10% CDF level), the data rate of maximal throughput scheduler may be essentially nil, while the rate of the proportional fairness scheduler may be 0.2.

### Computational Complexity Comparison

Referring to FIG. 6, a table of complexity comparisons is illustrated.

More particularly, the table compares the number of function evaluations of the optimal algorithm, the greedy algorithm and the genetic algorithm at various n_{R} and K. It should be note there may be an 8 times and 36 times speed-up in computation of genetic algorithm when compared with the optimal algorithm if (K, n_{R})=(10, 4) and (20,4), respectively.

While the particular invention has been described with reference to illustrative embodiments, this description is not meant to be construed in a limiting sense. It is understood that although the present invention has been described, various modifications of the illustrative embodiments, as well as additional embodiments of the invention, will be apparent to one of ordinary skill in the art upon reference to this description without departing from the spirit of the invention, as recited in the claims appended hereto. Consequently, the method, system and portions thereof and of the described method and system may be implemented in different locations, such as the wireless unit, the base station, a base station controller and/or mobile switching center. Moreover, processing circuitry required to implement and use the described system may be implemented in application specific integrated circuits, software-driven processing circuitry, firmware, programmable logic devices, hardware, discrete components or arrangements of the above components as would be understood by one of ordinary skill in the art with the benefit of this disclosure. Those skilled in the art will readily recognize that these and various other modifications, arrangements and methods can be made to the present invention without strictly following the exemplary applications illustrated and described herein and without departing from the spirit and scope of the present invention It is therefore contemplated that the appended claims will cover any such modifications or embodiments as fall within the true scope of the invention.

1. A method of wireless communication for a plurality of users, the method comprising:
scheduling at least two users of the plurality for transmitting data over an uplink using at least one of a plurality of transmission paths for each user in response to at least one of air interface characteristics, deadlines, uplink data transfer sizes and uplink data rates of the two users.

2. The method of claim 1, wherein the at least one of the air interface characteristics, the deadline, the uplink data transfer size and data rate of each user is determined from an uplink service request.

3. The method of claim 1, wherein the at least two users are scheduled by at least one of a maximum fairness scheme, a maximum throughput scheme, a maximum relative throughput scheme and a proportional fairness scheme for sharing resources amongst the at least two users.

4. The method of claim 1, wherein the user with a most desirable air interface characteristics is scheduled for transmitting the data over the uplink first using at least one of the transmission paths.

5. The method of claim 4, wherein the user with the next most desirable air interface characteristics is scheduled for transmitting data over the uplink using at least another of the transmission paths during or after the user with the most desirable air interface characteristics is scheduled.

6. The method of claim 1, wherein the user with a most desirable deadline is scheduled for transmitting the data over the uplink first using at least one of the transmission paths.

7. The method of claim 6, wherein the user with the next most desirable deadline is scheduled for transmitting data over the uplink using at least another of the transmission paths during or after the user with the most desirable deadline is scheduled.

8. The method of claim 1, wherein the user with a most desirable uplink data transfer size is scheduled for transmitting the data over the uplink first using at least one of the transmission paths.

9. The method of claim 8, wherein the user with the next most desirable uplink data transfer size is scheduled for transmitting data over the uplink using at least another of the transmission paths during or after the user with the most desirable uplink data transfer size is scheduled.

10. The method of claim 1, wherein the user with most desirable uplink data rate is scheduled for transmitting the data over the uplink first using at least one of the transmission paths.

11. The method of claim 10, wherein the user with the next most desirable uplink data rate is scheduled for transmitting data over the uplink using at least another of the transmission paths during or after the user with the most desirable uplink is scheduled.

12. A method of scheduling a plurality of users in a multiple antenna wireless communication system, the method comprising:
transmitting an uplink service request by a first user of the plurality to request a schedule for transmitting data on an uplink, the uplink service request comprising at least one of air interface characteristics, deadline, uplink data transfer size and uplink data rate corresponding with the first user; and
transmitting the data from the first user on the uplink using at least one of a plurality of transmission paths in response to the schedule determined.

13. The method of claim 12, wherein the schedule is determined in response to the at least one of the air interface characteristics, the deadline, the uplink data transfer size and the uplink data rate of the first user in comparison with at least another user of the plurality.

14. The method of claim 13, wherein the schedule is determined by at least one of a maximum fairness scheme, a maximum throughput scheme, a maximum relative throughput scheme and a proportional fairness scheme for sharing resources amongst the at least two users.

15. The method of claim 13, wherein the schedule for transmitting the data over the uplink for the first user using at least one of the transmission paths is determined if the first user comprises at least one of:
one of the most desirable air interface characteristics from the plurality of users;
one of the most desirable deadlines from the plurality of users;
one of the most desirable uplink data transfer sizes from the plurality of users; and
one of the most desirable data rates from the plurality of users.

16. A method of scheduling a plurality of users in a multiple antenna wireless communication system, the method comprising:
receiving an uplink service request from at least two users of the plurality, each uplink service request comprising at least one of air interface characteristics, deadline, uplink data transfer size and uplink data rate corresponding with one of the at least two users; and
scheduling each of the at least two users for transmitting data on an uplink using at least one of a plurality of transmission paths in response to at least one of the air interface characteristics, the deadline, the uplink data transfer size and the uplink data rate of the at least two users.

17. The method of claim 16, wherein the step of scheduling each of the at least two users comprises at least one of a maximum fairness scheme, a maximum throughput scheme, a maximum relative throughput scheme and a proportional fairness scheme for sharing resources amongst the at least two users.

18. The method of claim 16, wherein the step of scheduling each of the at least two users comprises evaluating the air interface characteristics, the deadline, the uplink data transfer size and the uplink data rate of the at least two users.

19. The method of claim 16, wherein the step of scheduling each of the at least two users comprises at least one of:
selecting at least one of the two users with one of the most desirable air interface characteristics;
selecting at least one of the two users with one of the most desirable deadlines;
selecting at least one of the two users with one of the most desirable uplink data transfer sizes; and
selecting at least one of the two users with one of the most desirable data rates.
